(19) United States
(12) Patent Application Publication
(10) Pub. No.: US 2012/0166402 A1
(43) Pub. Date: Jun. 28, 2012

(54) TECHNIQUES FOR EXTENDING HORIZONTAL PARTITIONING TO COLUMN PARTITIONING

(75) Inventors: Donald R. Pederson, San Diego, CA (US); Paul Sinclair, Manhattan Beach, CA (US); Steven B. Cohen, Redondo Beach, CA (US)

(73) Assignee: Teradata US, Inc., Dayton, OH (US)

(21) Appl. No.: 13/300,066

(22) Filed: Nov. 18, 2011

Related U.S. Application Data
(63) Continuation-in-part of application No. 12/979,526, filed on Dec. 28, 2010.

(51) Int. Cl. G06F 17/30

(52) U.S. Cl. 707/692; 707/737; 707/E17.046; 707/E17.005

(57) ABSTRACT

Techniques for extending horizontal partitioning to column partitioning are provided. A database table is partitioned into custom groups of rows and custom groups of columns. Each partitioned column is managed as a series of containers representing all values appearing under the partitioned column. A logical row represents a row of the table logically indicating each column value of a row. Compression, deletion, and insertion within the containers are managed via a control header maintained with each container.

### RELATED APPLICATIONS

The present application is co-pending with, is a Continuation-In Part of, and claims priority to U.S. Ser. No. 12/979,526 Entitled: “Techniques for Processing Operations on Column Partitions in a Database,” filed on Dec. 28, 2010; the disclosure of which is incorporated by reference in its entirety herein and below.

### BACKGROUND

In large commercial database systems it is often beneficial to partition the table of a database into smaller tables or segments, such that each smaller table or segment is capable of being individually accessed within a processing node. This promotes reduced input and output when only a subset of the partitions is referenced and improves overall database performance.

A popular approach to segmenting databases is referred to as row (or horizontal) partitioning. Here, rows of a database are assigned to a processing node (by hashing or randomly) and partitioned into segments within that processing node of the database system.

Another approach is to group columns together into segments (referred to as column or vertical partitioning), where each group of columns for rows assigned to a processing node are partitioned into segments within that processing node of the database system.

Both row and column partitioning have advantages to improving overall database performance.

In the past, some databases were originally organized as a hashed-based, row-oriented architecture. Subsequently, horizontal partitioning and multilevel horizontal partitioning were added. This was done by prefixing a hash value with a partition number (or combined partition number for multilevel partitioning) to form a row identifier (RowId) consisting of a partition number (0 if no horizontal partitioning), hash value (of which the first 16 or 20 bits are used as a hash bucket value that maps the value to a processing node), followed by sequentially generated uniqueness value (used to differentiate between rows with the same partition number and hash).

A more recent extension of database technology allows a table to be defined with a no-primary index (NoPI) table. For a NoPI table, the same row identifier structure is used except that an inserted row (or a set of inserted rows) are assigned to a processing node by using a round robin method (alternatively, a processing node may be randomly chosen), the hash bucket is sequentially chosen from the hash buckets assigned to that processing node (instead of determining a hash bucket by hashing the primary index values), and the remaining bits of the hash and the uniqueness are used for a sequentially generated uniqueness value (used to differentiate rows with the same partition and hash bucket). Note that inserts only add rows to the end of the table on a processing node. It is also noted that assignment of a row to a particular processing node can also be achieved by hashing on a particular field or set of fields in the row.

Another way to organize data rather than using rows is to organize the data by columns. This technique has been used in other databases. This approach of organizing data has distinct performance advantages for certain classes of query workloads. For example, if only certain columns are referenced, only those columns need be read from disk. In some ways, this can be considered as vertically partitioning the table on an individual column basis (note that a column itself could consist of multiple fields and provide vertical partitioning on subsets of columns so this approach does not preclude vertically partitioning a table). There are benefits of this column-based approach in the forms of optimizations and compression opportunities.

Ideally, it is desirable to support the option of selecting a row or a column layout for a table based on the workload characteristics. However, it is currently undesirable in the industry to support two different architectures and infrastructures for these two forms of storing data (horizontal and vertical partitioning) in the same database system due to the implementation and maintenance costs of such a dual implementation.

### SUMMARY

In various embodiments, techniques for extending horizontal partitioning to column (vertical) partitioning are presented. According to an embodiment, a method for extending a horizontal partition to a column partition of a database is provided.

Specifically, a first command for partitioning a database table based on one or more groupings of columns is detected. A second command for partitioning the database table into one or more groupings of rows is identified. Next, the database table is partitioned into the one or more groupings of the rows and into the one or more groupings of the columns. The database table is partitioned by both custom defined rows and custom defined columns.

### BRIEF DESCRIPTION OF THE DRAWINGS

FIG. 1 is a diagram of a method for extending a horizontal partition to a column partition of a database, according to an example embodiment.

FIG. 2 is a diagram of another method for extending a horizontal partition to a column partition of a database, according to an example embodiment.

FIG. 3 is a diagram of a horizontal-to-column partitioning processing system, according to an example embodiment.

### DETAILED DESCRIPTION

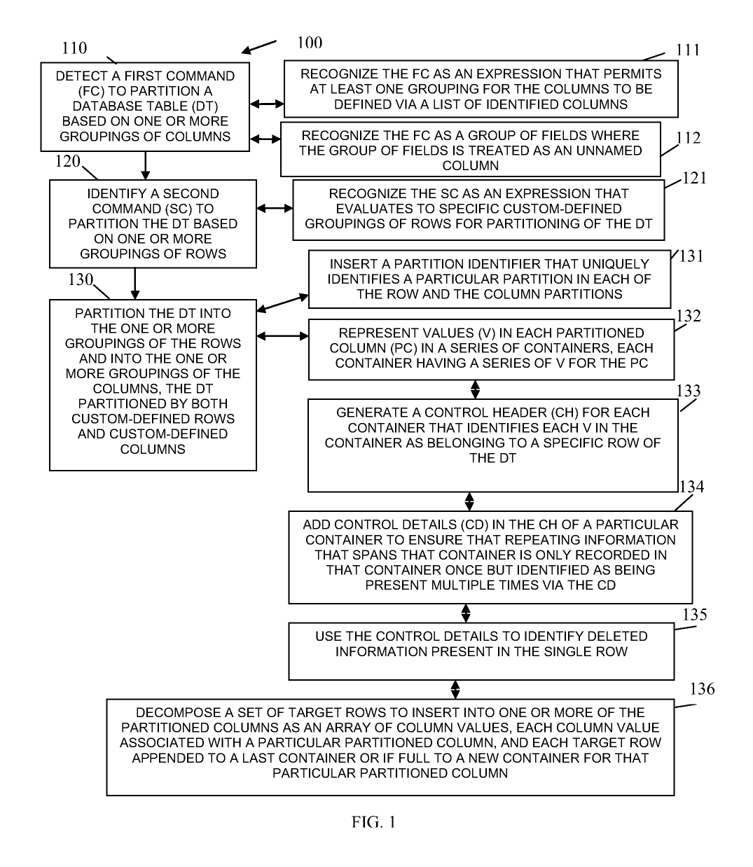

FIG. 1 is a diagram of a method 100 for extending a horizontal partition to a column partition of a database, according to an example embodiment. The method 100 (hereinafter “partition extender”) is implemented as instructions within a non-transitory computer-readable storage medium that execute on a plurality of processors, the processors specifically configured to execute the partition extender. Moreover, the partition extender is programmed within a non-transitory computer-readable storage medium. The partition extender may also be operational over a network; the network is wired, wireless, or a combination of wired and wireless.

Before discussing the processing associated with the partition extender some details regarding embodiments of the invention and context are presented.

A column partitioned (CP) table is provided. The CP table allows a table to be partitioned as separate columns using a column-based layout. Column partitioning is specified by extending the existing PARTITION BY syntax for horizontal partitioning to allow specification of COLUMN for a partitioning level instead of a partitioning expression as used for horizontal partitioning. For example:

Partition by Column

Note that a column may have a row or structured data type (fields of the row or structured type are not partitioned separately). Optional syntax allows specification of which columns to store as individual columns and which to group together:

Partition by Column (Column-Group-List)

In the above, the listed columns in a group (a group may list one or more columns) are stored in separate partitions with any remaining columns stored as a group in one partition.

Partition by Column all but (Column-Group-List)

In the above, each listed column group (a group may list one or more columns) is stored as a group in one partition (each such group is in a separate partition) with the remaining columns stored in separate partitions.

One or more groups of columns are defined where each group is stored in separate partitions (a group can be indicated by a parenthesized list of columns within the column group lists above).

Other syntax variations to specify which columns are stored in separate partitions or grouped in one partition are possible, such as shown below by grouping columns in the definition list of a CREATE TABLE statement.

This allows fast and efficient access to a subset of columns that are needed for evaluating predicates and projection (currently, entire rows must be read to apply column predicates and project columns). A CP table also allows for optimization and compression opportunities (e.g., fewer row headers, run length compression, etc.).

Column partitioning can be combined with the existing horizontal partitioning capabilities to provide benefits of both horizontal and column partitioning using multilevel partitioning. For example:

Partition by (Column, Range_N( . . . ), . . . )

Horizontal partitioning can be used for near or actual value ordering to increase run lengths and, thereby, improve the effectiveness of run length compression when used with column partitioning.

The proposed implementation builds on horizontal partitioning (from PPI/MLPPI/IPL) and no primary index (NoPI) syntax and infrastructures.

The following example illustrates a suggested syntax for specifying a CP table (bold font indicates a new syntax for column partitioning):

CREATE TABLE t

(p INTEGER, c INTEGER),
d1 DATE,
d2 BYTEINT,
d3 SMALLINT,
(a1 CHAR(100), a2 VARCHAR(1000)))

NO PRIMARY INDEX

PARTITION BY
(COLUMN ADD 50,

RANGE_N(d1 BETWEEN DATE ‘2006-01-01’

AND DATE ‘2010-12-31’

EACH INTERVAL ‘1’ MONTH),

RANGE_N(d2 BETWEEN 1 and 4 EACH 1))

UNIQUE INDEX (p, c);

The following describes novel points about this syntax:
1. PARTITION BY—specifies one or more levels of partitioning. One level may specify column partitioning. Other levels, if any, may specify partitioning expressions (using RANGE_N or CASE_N) for horizontal partitioning.
2. COLUMN—defines that the table has column partitioning with partitions 1 through 5 corresponding to the columns defined for the table.
3. ADD 50—defines the number of partitions that may be added using ALTER TABLE for the partitioning level. If this is for the COLUMN partitioning level, this also defines the number of columns that can be added to the table since each column added will add an additional partition. This is optional. Note that this is not specific to column partitioning. This can also be specified for horizontal partitioning to allow growth in the number of partitions for that level.
4. RANGE_N(d2 BETWEEN 1 and 4 EACH 1)—as currently, defines a partitioning expression for a horizontal level of partitioning. Alternatively, this can be a CASE_N expression.
5. (a1 character(100), a2 varchar(1000))—specifies a group of fields where the group is treated as a single unnamed column of an unnamed row type. Field and column names are unique for a table so fields can be referenced in queries without a qualifying name. The fields of this column are not partitioned separately. TRANSACTIONTIME and VALIDTIME may be defined as a field instead of a column. Optionally, the group of fields can be given a name—column_name (field_list) or column_name ROW(field_list) where ROW may indicate storage in row format instead of mini-rows within a column format.
6. NO PRIMARY INDEX—this may be omitted if the default is NO PRIMARY INDEX when PRIMARY INDEX is not specified. Alternatively, a primary index (hashed distribution and hash ordering of rows within partitions) can be specified or PRIMARY Application Module Processor (AMP) (for hash distribution only based on the hash of set of columns) though there could be significant impact on loading data when using these forms (efficient block inserts would be broken up into much less efficient row-at-time inserts). Also, if a PRIMARY INDEX is specified, storage needs would increase significantly (and, thereby, impact performance) if the primary index columns are unique or fairly unique (for example, less than 100 or so rows per value). So NO PRIMARY INDEX it is expected to be the usual choice for a table with column partitioning.

Note all the rules about partitioning such as the limit on the total number of combined partitions apply.

The remaining context describes an architecture and design to support techniques presented herein for extending horizontal partitioning to column partitioning.

Currently, for a table with a primary index, RowId consists of a 2-byte internal partition number (0 if not partitioned) corresponding to the combined partition number computed from the partitioning expressions, 4-byte hash (or the primary index columns), and 4-byte uniq. Other variations of this approach allow different sizes for the RowId fields (for instance, using 8 bytes for the internal partition number).

A CP table uses the same RowId structure. The columns are associated with a number denoting their partition (for, example, number the columns from 2 to the number of partitions+1; partition 1 is used for an internal control column). This partition number can be used in the calculation of the combined partition number in the same manner as for horizontal partitioning. For consistency, a column partition number of 1 is used for the COLUMN level when the RowId is referencing an entire logical row. To reference a specific column in a logical row, the RowId can be modified to set the partition number for that column in the internal partition number. Therefore, join indexes and NUSIs/USIs still just reference RowIDs that point to logical rows.

A partition inclusion list for just the horizontal levels can indicate that only partition number 1 of the COLUMN level is included. Or the partition inclusion list can be for all levels indicating the included COLUMN level partitions (corresponding to the referenced columns). COLUMN level partition elimination is very simple to determine since it is based on whether a column is referenced or not in the query (after eliminating any extraneous references that do not contribute to the result).

When a row is inserted, a RowId is determined as above for each column value and each column value will be stored based on its RowId value. With the current structure, each column value would then be stored in a physical row by itself. However, storing each column value as a physical row might introduce too much overhead (each physical row has a row header and other information that may exceed the size of the column value) and very often it will be a very small physical row. Instead, for a column partition, column format can be used where multiple column values are stored in a physical row, referred to as a container, which has a rowheader like a traditional physical row. Each container will only contain column values that have the same internal partition number and hash (which includes the hash bucket) for a NoPI table or the same partition number and hash value for a PI table. The rowheader for a container indicates the internal partition number, hash (which includes the hash bucket), and row number (or uniq) for the first row in the container. The container may have presence bits and VLC bits similar to regular physical row except that these correspond to a sequence of column values for the same column, rather than columns values for a row. A container may also contain run lengths for repeating values. In addition, there may be bits to indicate whether a column value is for a row that has been deleted or not (or this information may be kept in an added internal control column). Note that containers should have 1,000's of column values in them for short fixed/variable length data types (unless the table is overly horizontally partitioned) for a NoPI table, PRIMARY AMP table or a very nonunique PRIMARY INDEX table. This is a key factor in reducing the overhead in storing such data and in achieving high compression ratios. For a table that is overly partitioned or a PRIMARY INDEX table that is unique or fairly unique, the number of values may be much less and will not benefit much, if any, from the compression of multiple column values into containers. Additionally, other methods could be applied to compress the container. Note that the row number (for NoPI and PRIMARY AMP) and uniq (for PRIMARY INDEX) are sequentially incremented for the column values as rows are inserted so, within a container, the column value for a specific RowID can be determined by examining the presence bits, VLC bits, delete bits, and run lengths. The delete bits or control column indicate which values have been deleted so that the relative position of rows in a container does not change. Note that a container can be deleted when all the column values in it have been deleted.

If column values for a column are relatively large, storing multiple values in a container may actually introduce more overhead and/or make it more costly to update a column value. An option such as specifying ROW(column-list) in the column definition list of the table or in the COLUMN partitioning specification where a column-group-list may define one or more columns in a group could be provided that indicates column values are to be stored in individual physical rows, rather than in containers. If ROW is not specified, the system could decide whether row or container format is used based on the size defined for the column value and system- or user-defined thresholds. To force use of containers for a column, an option such as specifying COLUMN(column-list) could be provided.

A set of rows to insert can be deconstructed into arrays of column values and then each array can be appended to an existing matching container or a new container can be appended. Note that the “set” may only be a single row, for example, a single-row INSERT statement. Therefore, more efficiency is obtained with INSERT-SELECT or load utilities that deal with multiple rows.

Given a RowId, a column value for this row can be obtained as follows:
1. The hash bucket locates the AMP as usual (the RowId would have been distributed to the correct AMP for processing as usual).
2. Set the target column's partition number in the internal partition number of the RowId.
3. Use the file system to locate the container based on the RowId. The container row is the one with the largest RowId less than or equal the requested RowId.
4. Set p to the row number (or uniq for a PI table) from the target RowId minus the row number of the container's RowId.
5. Set v to 0.
6. Go through the presence bits, set v to v+the current the run length, advance to the next set of bits, and repeat this step,

Step 6 becomes slightly more complicated if this is a variable length column, negative run lengths indicate deleted values (instead of using delete bits), or a control column is used to specify deleted rows. In such cases, extra calculations are required to find the exact location of the column value in the container. This can also be simplified if the column is NOT NULL (and, therefore, presence bits are not used), VLC is not used for this table or container, or run lengths are not used for this column or container. Also, going through the bits can be further optimized. But this is all straightforward logic.

Besides the compression techniques described above, other compression techniques could be implemented for a container. Some compression techniques such as block compression would require uncompressing the entire container before looking for a column value. This may cause the container to expand significantly and use more memory—at minimum, it doubles the memory needed since, at least temporarily, two copies of the container are needed (the compressed form and the uncompressed form) and usually much more if the compression is effective in reducing the size of the container.

Multiple file partitions can be used to efficiently read non-eliminated column partitions applying column predicates, and combine projected columns to form spool rows. An inclusion list for the horizontal partitions is used the same as currently to only read the non-eliminated horizontal partitions of the column partitions. This can be done in parallel.

One way to scan a CP table and form result rows is a join approach like a PPI sliding-window join. Say we are joining on 3 columns on row numbers—we have 3 contexts open to the start of each column and move them forward as we apply predicates, if any, to column values and form result rows. For example, where Row# is not a real column but a row position within AMP/part/bucket in the table (assume 1 AMP):

CREATE TABLE Orders

(Order# INTEGER, Item# INTEGER, Spec_Inst
VARCHAR(1000))

NO PRIMARY INDEX PARTITION BY COLUMN;

| Order# | Item# | Spec_Inst | Row# |
|---|---|---|---|
| 1 | 6 | null | 1 |
| 2 | 85 | Ship Fedex to James houses . . . | 2 |
| 8 | 7 | Ship to Jones at Washington DC . . . | 3 |
| 4 | 1 | Hold until next blue moon | 4 |

SELECT Order#, Spec_Inst FROM Orders

WHERE Item#=7 AND Spec_Inst LIKE ‘Jones’;

One suggested process is as follows:
1. The ret step opens three file contexts for the Item#, Spec_Inst, and Order# column partitions in Orders.
2. Set CurrRowId to the first non-eliminated combined partition with the column partition number for Item#, hash bucket at lowest hash bucket for this AMP, and row position is 1.
3. Using Item#'s file context, position within the table to the first non-eliminated container with a beginning RowId that is greater than or equal to CurrRowId (if there are no more containers for this column, go to step 9)—when positioning, handle partition elimination based on the inclusion list, if any, plus eliminate all column partitions except for Item#'s partition. Set CurrRowId to the beginning RowID for this container and locate the first column value in this container.
4. If the current column value is not equal to 7, go to step 8.
5. Set SIRowid to a modified copy of CurrRowId (set Spec_Inst's column partition number in the internal partition number of the RowId). Using Spec_Inst's file context, position to the container that includes the column value for SI Rowid. Use the most appropriate file system call to position to this container depending on whether it is close by or farther away, or avoid a file system call if Spec_Inst's file context is already positioned to this container. Locate the column value corresponding to SIRowid within this container.
6. Perform the LIKE predicate with this Spec_Inst column value and ‘Jones’.
7. If the LIKE predicate is true, spool CurrRowId for a later join back or build a row of the projected columns (Order# and Spec_Inst) as follows:
   a. For the column value for Order#, set O#Rowid to a modified copy of CurrRowId (set Order#'s column partition number in the internal partition number of the RowId). Using Order#'s file context, position to the container that includes the column value for O#Rowid. Use the most appropriate file system call to position to this container depending on whether it is close by or farther away, or avoid a file system call if Order#'s file context is already positioned to this container. Locate the column value corresponding to O#Rowid within this container.
   b. For the column value Spec_Inst, pick up the column value determined in step 5.
8. Increment CurrRowId (if the size of the row number would exceed its maximum value, set the hash bucket to the next higher hash bucket for this AMP and set the row number to 1). If there are no more column values for this container, go to step 3. Otherwise, locate the next column value in the container and go to step 4.
9. Done.
   It is noted that the above mentioned approach is one implementation that can be done and that many different implementations can be achieved without departing from the beneficial teachings presented herein and above. Therefore, it is noted that any implementation specific approached presented herein are for purposes of illustration and comprehension and are not to be viewed in a limiting sense on the embodiments of the invention.

The above approach is demonstrated for “ANDed” conditions—this can be extended to “ORed” conditions, set operations, and residual conditions that can only be evaluated after joining the one or more column values to which they apply. Other variations on this approach are possible for further optimizations.

In summary, one key concept introduced in embodiments herein is that a table's columns can be partitioned by a straightforward extension of the relational database architecture. A column partitioning specification option is added to the current horizontal partitioning specification. Columns are assigned sequential partition numbers. Instead of storing each column value of column partition as a physical row, multiple column values are concatenated in a container with one row-header reducing the storage space needed to store column values.

The same infrastructures such as row identifiers and inclusion lists can be used and can support column partitioning, horizontal partitioning, or a combination of both via a partition number (or combined partition number for multilevel partitioning). Reading columns used by the query and joining values for those columns to values of other the columns for a row can be accomplished in similar manner as reading from multiple horizontal partitions. The handling of containers and deconstructing and reconstructing rows from columns can be isolated such that much of the relational database continues to deal with rows.

From a user point of view, a CP table is easy to define and works well with other features such as horizontal partitioning and no primary index tables.

This differs from other implementations in that it combines both vertical and horizontal partitioning of data storage (instead of supporting one or the other, or having two separate implementations) via a straightforward, low cost extension to the current relational database architecture.

It is with this initial discussion of the approaches described herein that the processing associated with the FIGS. 1-3 is now discussed.

Referring now to the FIG. 1 and the processing associated with the partition extender.

At 110, the partition extender detects a first command to partition a database table based on one or more groupings of columns (vertical or column partitioning). The groupings can be custom defined and database language syntax can be used to identify and interpret the column groupings designated for partitioning. The details associated with this were discussed above and samples were provided for illustration.

According to an embodiment, at 111, the partition extender recognizes the first command as an expression that permits at least one grouping for the columns to be defined via a list of columns (identified by column identifiers). This was presented above and a sample database language command or commands provided for achieving this as well.

In another case, at 112, the partition extender recognizes the first command as a group of fields where the group of fields is treated as a customized unnamed column. So, columns can be logically created from the table based on sets of fields. This too was discussed above.

At 120, the partition extender identifies a second command to partition the database table based on one or more groupings of rows (horizontal partitioning). So, both horizontal and vertical partition is achieved. Again, the details of extending horizontal partitioning with vertical/column partitioning were presented in great length above.

According to an embodiment, at 121, the partition extender recognizes the second partition as a custom and user-defined expression that evaluates to specific custom-defined groupings of rows for partitioning of the database table. Examples for this were presented above with the use of the RANGE command and scenarios discussed above.

At 130, the partition extender partitions the database table into the one or more groupings of the rows and into the one or more groupings of the columns. The database table partitioned by both custom-defined rows and custom-defined columns.

According to an embodiment, at 131, the partition extender inserts a partition identifier that uniquely identifies a particular partition in each of the row and column partitions.

In another case, at 132, the partition extender represents each of the rows in each partitioned column as a logical container having a single row. This ensures that memory and processor efficiencies are achievable so a single column having multiple rows is really represented as a single concatenated row, each cell in the single row representing a particular real row under the partitioned column. This provides a variety of processing benefits and efficiencies.

For example, at 133, the partition extender generates a control header for each container that identifies each value in the container as belonging to a specific row of the table.

Continuing with the embodiment of 133 and at 134, the partition extender adds control details in the control header of a container to ensure that repeating information or data in cells of the container is only recorded once in the container but identified in the control details as specifically occurring multiple times in multiple cells of the container. This provides a form of compression to reduce memory and/or storage requirements.

Still continuing with the embodiment of 134 and at 135, the partition extender uses the control details to identify deleted information present in a container.

In yet another situation of 135 and at 136, the partition extender decomposes a set of source rows to insert into one or more of the partitioned columns as an array of column values. The values of such an array appended to the last container (or if full a new container) associated with a particular partitioned column and each partitioned row.

It is also noted that the control header for the container can be a bit map that is dynamically interpreted and processed to achieve the processing discussed herein and above.

It is now understood how horizontal partitioning can be efficiently extended with column partitioning against a same database table.

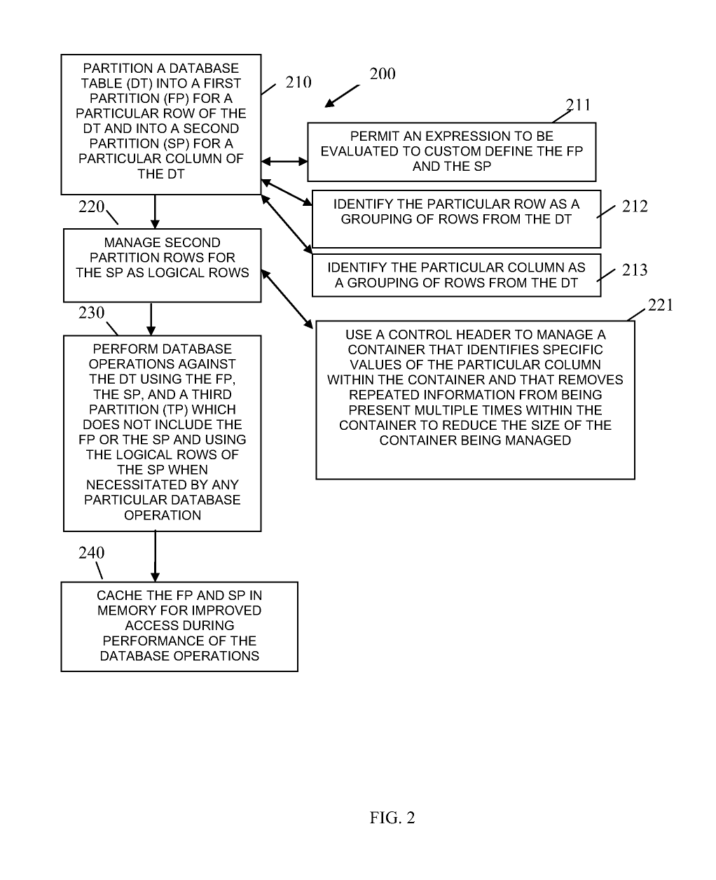

FIG. 2 is a diagram of another method 200 for extending a horizontal partition to a column partition of a database, according to an example embodiment. The method 200 (hereinafter “partition manager”) is implemented as instructions within a non-transitory computer-readable storage medium that execute on a plurality of processors, the processors specifically configured to execute the partition manager. Moreover, the partition manager is programmed within a non-transitory computer-readable storage medium. The partition manager may also be operational over a network; the network is wired, wireless, or a combination of wired and wireless.

The partition manager presents another and in some ways an enhanced processing perspective to that which was discussed and shown above with respect to the partition extender, represented by the method 100 of the FIG. 1.

At 210, the partition manager partitions a database table into a first partition for a particular row of the database table and into a second partition for a particular column of the database table. Both horizontal and vertical partitioning is achieved.

According to an embodiment, at 211, the partition manager permits an expression to be dynamically evaluated to custom define the first partition and the second partition. Again, how this is done, sample syntax for achieving this, and examples for doing this were presented above with reference to the FIG. 1.

In another situation, at 212, the partition manager identifies the particular row as a grouping of multiple rows from the database table.

Similarly, at 213, the partition manager identifies the particular column as a grouping of multiple columns from the database table.

At 220, the partition manager manages second partition rows (the partitioned column's rows) as a single logical row. This provides a variety of efficiencies that were discussed in detail above with reference to the FIG. 1.

For example, at 221, the partition manager uses a control header of a container to manage the values in the container, which identifies specific rows of the table that the values belong and that also is used to remove repeated information from being present multiple times within the container to reduce the size of the container that is being managed.

At 230, the partition manager performs database operations against the database table using the first partition and the second partition and a third partition which does not include the first partition or the second partition. Also, the single logical row of the second partition is used and manipulated when necessitated by any particular database operation. In other words, the first and second partitions may be those aspects of the database table that are frequently used and the third partition is those aspects used less frequently. The third partition includes items from the database table not represented in the first and the second partitions.

According to an embodiment, at 240, the partition manager caches data from the first partition and the second partition into memory for improved access during performance of the database operations. This may also greatly improve the processing throughput of processing the database operations.

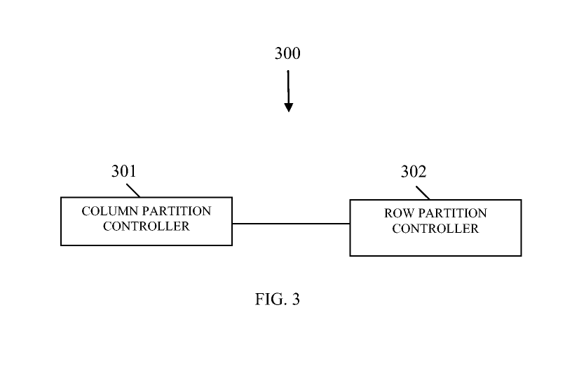

FIG. 3 is a diagram of a horizontal-to-column partitioning processing system 300, according to an example embodiment. The horizontal-to-column partitioning processing system 300 is implemented, resides, and is programmed within a non-transitory computer-readable storage medium and executes on one or more processors specifically configured to execute the components of the horizontal-to-column partitioning processing system 300. Moreover, the horizontal-to-column partitioning processing system 300 may be operational over a network and the network is wired, wireless, or a combination of wired and wireless.

The horizontal-to-column partitioning processing system 300 implements, inter alia, the techniques presented and described above with reference to the FIGS. 1-2.

The horizontal-to-column partitioning processing system 300 includes a column partition controller 301 and a row partition controller 302. Each of these and their interactions with one another will now be discussed in turn.

The column partition controller 301 is programmed and implemented within a non-transitory computer-readable storage medium for execution on one or more processors of the network. The one or more processors are specifically configured to process the column partition controller 301. Details of the column partition controller 301 were presented above with respect to the methods 100 and 200 of the FIGS. 1 and 2, respectively.

The column partition controller 301 is configured to custom partition a database table into one or more groupings of columns.

According to an embodiment, the column partition controller 301 is also configured to represent and manage a particular partitioned column as a series of containers each representing series of values of the partitioned column.

Continuing with the embodiment of above, the column partition controller 301 is also configured to use a control header of a container to identify the row each value in the container belongs.

Still continuing with the last embodiment, the column partition controller 301 is also configured to represent in the control header of a container repeated information to ensure that information appears just once within the container.

The row partition controller 302 is programmed and implemented within a non-transitory computer-readable storage medium for execution on one or more processors of the network. The one or more processors are specifically configured to process the row partition controller 302. Details of the row partition controller 302 were presented above with respect to the methods 100 and 200 of the FIGS. 1 and 2, respectively.

The row partition controller 302 is configured to custom partition the database table into one or more groupings of rows.

The techniques herein describe mechanisms for extending row or horizontal partitioning with efficient column or vertical partitioning.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented and programmed within a non-transitory computer-readable storage medium and processed by a processor, the processor configured to execute the method, comprising:
detecting, via the processor, a first command to partition a database table based on one or more groupings of columns;
identifying, via the processor, a second command to partition the database table based on one or more groupings of rows; and
partitioning, via the processor, the database table into the one or more groupings of the rows and into the one or more groupings of the columns, the database table partitioned by both custom-defined rows and custom-defined columns.

2. The method of claim 1, wherein detecting further includes recognizing the first command as an expression that permits at least one grouping for the columns to be defined via a list of identified columns.

3. The method of claim 1, wherein detecting further includes recognizing the first command as a group of fields where the group of fields is treated as an unnamed column.

4. The method of claim 1, wherein identifying further includes recognizing the second command as an expression that evaluates to specific custom-defined groupings of rows for partitioning of the database table.

5. The method of claim 1, wherein partitioning further includes inserting a partition identifier that uniquely identifies a particular partition in each of the row and the column partition combinations.

6. The method of claim 1, wherein partitioning further includes representing values in each partitioned column in a series of containers where each container includes a series of values of that partitioned column.

7. The method of claim 6, wherein representing further includes generating a control header for each container that identifies each value in that container as belonging to a specific row of the table.

8. The method of claim 7, wherein generating further includes adding control details in the control header of a particular container to ensure that repeating information that spans that container is only recorded in that container once but identified as being present multiple times via the control details.

9. The method of claim 8 further comprising, using the control details to identify deleted information present in the single row.

10. The method of claim 9 further comprising, decomposing a set of target rows to insert into one or more of the partitioned columns as an array of column values, each column value associated with a particular partitioned column, and each target row appended to a last container or if full to a new container for that particular partitioned column.

11. A method implemented and programmed within a non-transitory computer-readable storage medium and processed by a processor, the processor configured to execute the method, comprising:
partitioning, via the processor, a database table into a first partition for a particular row of the database table and into a second partition for a particular column of the database table;
managing, via the processor, second partition rows for the second partition as logical rows; and
performing, via the processor, database operations against the database table using the first partition, the second partition, and a third partition which does not include the first partition or the second partition and using the logical rows of the second partition when necessitated by any particular database operation.

12. The method of claim 11 further comprising, caching the first partition and the second partition in memory for improved access during performance of the database operations.

13. The method of claim 11, wherein partitioning further includes permitting an expression to be evaluated to custom define the first partition and the second partition.

14. The method of claim 11, wherein partitioning further includes identifying the particular row as a grouping of rows from the database table.

15. The method of claim 11, wherein partitioning further includes identifying the particular column as a grouping of rows from the database table.

16. The method of claim 11, wherein managing further includes using a control header to manage a container that identifies specific values of the particular column within the container and that removes repeated information from being present multiple times within the container to reduce the size of the container being managed.

17. A processor-implemented system, comprising:
a column partition controller programmed within a non-transitory computer-readable medium and to execute on a processor; and
a row partition controller residing within a non-transitory computer-readable medium and to execute on the processor;
the column partition controller configured to custom partition a database table into one or more groupings of columns and the row partition controller configured to custom partition the database table into one or more groupings of rows.

18. The system of claim 17, wherein the column partition controller is configured to represent and manage a particular partitioned column as a series of values for the partitioned column.

19. The system of claim 18, wherein the column partition controller is configured to use a control header to identify the specific row for which a particular value belongs within the container.

20. The system of claim 18, wherein the column partition controller is configured to represent in the control header of a container repeated information to ensure information appears once within the that container.
